(19) United States
(12) Patent Application Publication
(10) Pub. No.: US 2005/0022217 A1
(43) Pub. Date: Jan. 27, 2005

(54) Ejecting apparatus of a tray-type disk drive

(76) Inventor: Ming-Huang Lee, Sanchong City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/896,633

(22) Filed: Jul. 21, 2004

(30) Foreign Application Priority Data
Jul. 21, 2003 (TW) 092119895

(51) Int. Cl. G11B 33/02

(52) U.S. Cl. 720/606; 720/601

(57) ABSTRACT

An ejecting apparatus is applied to a tray-type disk drive with a disk tray. The ejecting apparatus has a driving device, a front faceplate, and a rod. The driving device is located within the tray-type disk drive. When the rod touches the driving device, the disk tray withdraws from the tray-type disk drive. The front faceplate is installed at the front part of the tray-type disk drive and the front faceplate has an aperture. The internal end of the rod is located facing the driving device and the external end of the rod protrudes through the aperture of the front faceplate. When the external end of the rod is pressed, the rod touches and activates the driving device so that the disk tray will be ejected from the tray-type disk drive.

This application incorporates by reference Taiwan application Serial No. 92119895, filed Jul. 21, 2003, the subject matter of which is incorporated herein by reference.

### BACKGROUND OF THE INVENTION

1. Field of the Invention

The invention relates in general to a disk-withdrawing apparatus, and more particularly to an ejecting apparatus that is applied in a tray-type disk drive.

2. Description of the Related Art

Almost all the multimedia products are issued in the form of compact disks (CD) nowadays. Due to the popularity of consumable CDs, almost every computer has a disk drive. The significance of disk drive in the area of multimedia is very evident.

Referring to FIG. 1, a diagram for a traditional ejecting apparatus is shown. The ejecting apparatus is used in tray-type disk drive 100. The ejecting apparatus has a driving device (located inside the tray-type disk drive 100, and is not shown in FIG. 1), a front faceplate 110, and a rod 115.

By touching the driving device, which is located inside the tray-type disk drive 100, the disk tray 120 can be ejected from the disk drive 100.

Usually, there are a disk tray 120, an earphone jack 130, a volume control 140, a busy-indicator light 150, a withdraw button 160, and an emergent disk-withdraw aperture 170 on the front faceplate 110.

Generally speaking, by pressing the withdraw button 160 when the tray-type disk drive 110 is powered on, the disk tray 120 can be ejected from the tray-type disk drive 100. When the disk tray 120 is in a fixed position, a compact disk can be placed in or removed from the disk tray 120.

If the disk tray 120 could not be ejected by the method mentioned above, or if the disk tray 120 needs to be ejected while the tray-type disk driver 110 is powered off, a rod 115 is used to be inserted into the ejecting aperture to touch and to activate the driving device in order to force the withdraw of the disk tray 120.

It is a task to look for the rod 115 in emergency. It could be inconvenient and time wasting. If by any chance, the rod 115 is lost and there is no substitution nearby, chance of emergent ejection of the disk tray 120 from the tray-type disk drive 100 could be lost.

### SUMMARY OF THE INVENTION

It is therefore an object of the invention to provide an ejecting apparatus that is applied to a tray-type disk drive for the purpose to efficiently eject the disk-receiver from the tray-type disk drive without the need to spend time searching for a rod.

The invention achieves the above-identified objects by providing an ejecting apparatus that is applied to a tray-type disk drive with a disk-receiver. The ejecting apparatus has a driving device, a front faceplate and a rod. The driving device is located within the inside the tray-type disk drive. When the rod touches the driving device, the disk-receiver withdraws from the tray-type disk drive. The front faceplate is installed at the front part of the tray-type disk drive and the front faceplate has an aperture. The internal end of the rod is located facing the driving device and the external end of the rod protrudes out of the front faceplate through the aperture. The pushing rod is connected to the rod by a swivel pivot by which the pushing rod can be rotated to align with the rod, and by pushing the pushing rod the rod can touch and activate the driving device. The pushing rod can also be rotated to lie flat on the front faceplate. The spring is used to connect the rod and the front faceplate. After the spring has been pushed, it exerts pressure to return the rod back to its original position. Wherein, the ejecting apparatus also includes the light-emitting device that is installed in the tray-type disk drive or on the rod and is used to display the operation status of the tray-type disk drive. The material of the rod is pervious to light, and therefore the light beam emitted by the light-emitting device can travel through the tail end of the rod and can be displayed on the front faceplate. Besides, the material of the pushing rod could also be pervious to light. The light beam emitted by the light-emitting device can reach the tail end of the rod and the pushing rod and be displayed on the front faceplate. The light-emitting device could be light emitting diode (LED).

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is the diagram for a traditional ejecting apparatus.

FIG. 2 is the diagram for the ejecting apparatus according to the preferred embodiment of the invention.

FIG. 3A is the vertical view of the front faceplate of FIG. 2.

FIG. 3B is a diagram showing when the push rod of FIG. 3A is in an erected position.

FIG. 3C is the diagram showing that the driving device is touched when the erected pushing rod is pushed.

FIG. 4 is the diagram showing that the light-emitting device is located within the rod.

### DETAILED DESCRIPTION OF THE INVENTION

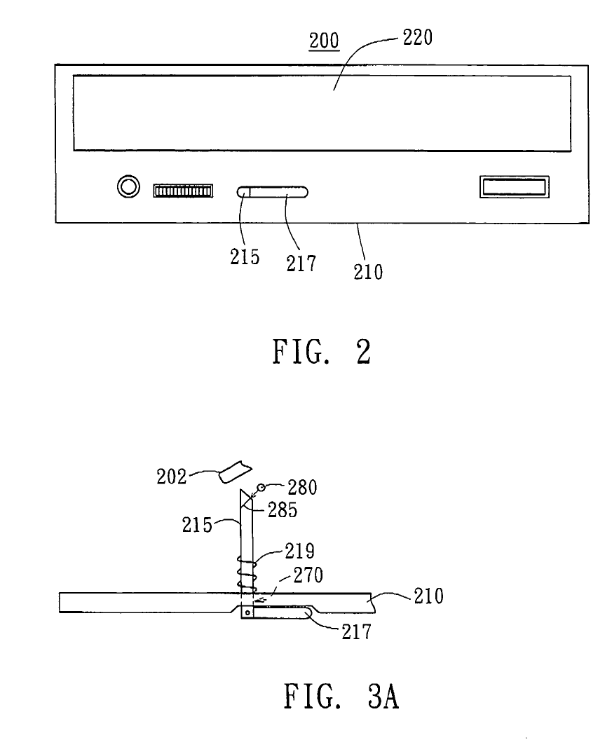

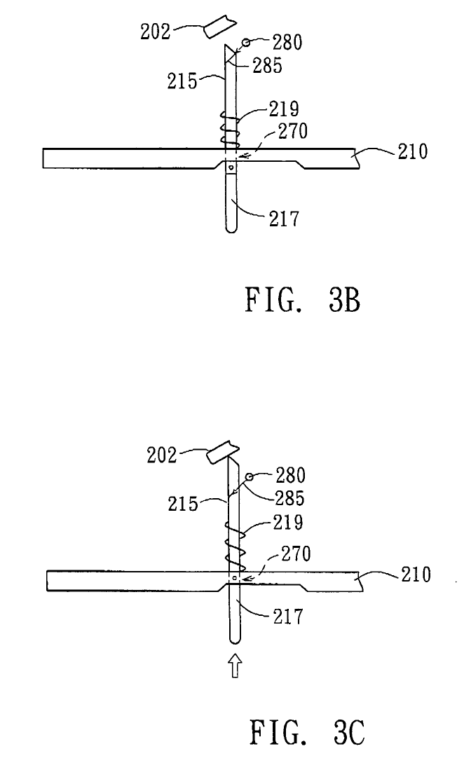

Please refer to FIG. 2, FIG. 3A, FIG. 3B, and FIG. 3C. FIG. 2 is a diagram of an ejecting apparatus according to the preferred embodiment of the invention. FIG. 3A is a vertical view of the front faceplate in FIG. 2. FIG. 3B is a diagram showing when the push rod of FIG. 3A is in an erected position. FIG. 3C is a diagram showing the push rod is pushed to touch the driving device.

The ejecting apparatus can be used in tray-type disk drive 200. The ejecting apparatus primarily includes a driving device 202, a front faceplate 210, a rod 215, a push rod 217, and a spring 219. By touching the driving device 202, which is located inside the tray-type disk drive 220, the disk tray 220 can be ejected from the tray-type disk drive 220.

The front faceplate 210 is installed at the front part of the tray-type disk drive 200 and the front faceplate 210 has an aperture 270 within which the rod 215 is installed. The head end of the rod 215 is located facing the driving device 202 and the tail end of the rod 215 protrudes out of the front faceplate 210 through the aperture.

The pushing rod 217 is connected to the tail end of the rod 215 by a swivel pivot, therefore the push rod 217 can rotate relatively to the rod 215 on the tail end of the rod 215. Please refer to 3A; the pushing rod 217 can rotates and lies flat on the front faceplate 210 when the rod, which is installed in the aperture 270, is not used.

Please refer to 3B; when the rod 215 needs to be used, the pushing rod 217 can be erected and aligned with the rod 215. Then, by pushing the erected pushing rod 217 in the direction of the arrow shown in FIG. 3C, the rod 215 can touch and activate the driving device 202.

The spring 219 shown in FIG. 3A to FIG. 3C is used to connect the rod 215 and the front faceplate 210. After the pushing rod 217 had been pushed, the distorted spring 219 exerts pressure on the rod 215 and thus returns the rod 215 to its original position. The function of the spring 219 is evident in FIG. 3C.

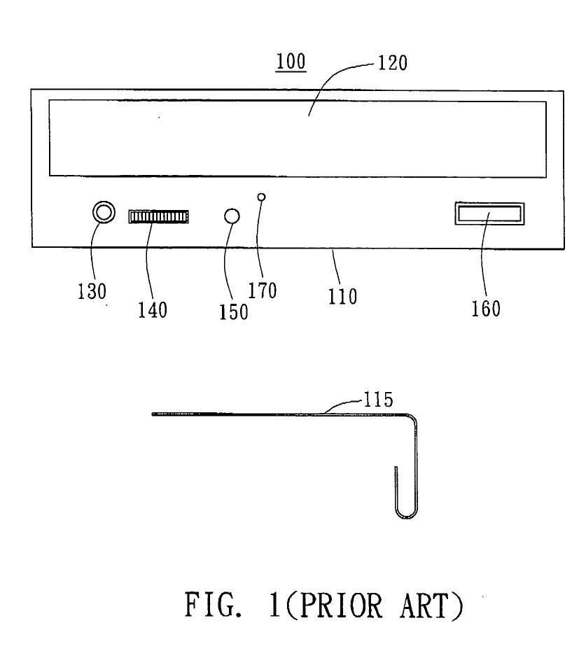

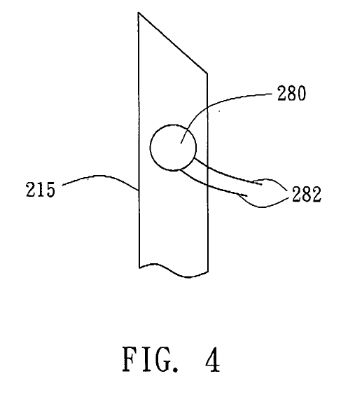

The ejecting apparatus discussed above can also be used to indicate the operation status of the tray-type disk drive 220 by installing a light-emitting device 280 inside the disk drive 200 or on the rod 215. What is shown in FIG. 3A to FIG. 3C is an example of the light-emitting device 280 installed near to the rod 215 inside the disk drive 200. The light-emitting device 280 can also be installed within the rod 215 as shown in FIG. 4. And the electrodes 282 of the light-emitting device 280 can be connected to a power source outside the rod 215. The material of the rod 215 can be pervious to light. The light beam 285 emitted from the light-emitting device 280 can be shown on the front faceplate 200 via the tail end of the rod 215 in order to replace the traditional busy-indicator light 150 (in FIG. 1).

Besides, the material of the pushing rod 217 can also be pervious to light. The light beam 285 emitted by the light-emitting device 280 can reach the tail end of the rod and the pushing rod and be displayed on the front faceplate 210. The light-emitting device 280 could be light emitting diode (LED).

If the rod 215 is installed in the aperture 270 in the ejecting apparatus discussed above and the tail end of the rod protrudes out of the front faceplate 210 through the aperture, then the pushing rod 217 is no longer required. By directly pushing the tail end of the rod 215, the head end of the rod can touch the driving device 202. And after the poking needed is pushed, the spring 219 is distorted and therefore exerts a restoring pressure on the rod 215. The rod 215 can be returned to its original position.

The material of the rod 215 can also be any material that is pervious to light in order to show the operation status of the tray-type disk drive 200. The light beam 285 emitted from the light-emitting device 280 can be shown on the front faceplate 200 by the tail end of the rod 215. The light-emitting device 280 can also be a LED.

Now, it can be understood that, according to the ejecting apparatus of the invention, the rod 215 is directly installed in the aperture of the front faceplate. By directly pressing the tail end of the rod 215 or by pushing the pushing rod 217, which in turn pushes the rod 215, the head end of the rod could touch the driving device 202 and thus the disk tray 220 can be ejected-from the tray-type disk drive 200. In the other hand, because the rod 215 and the pushing rod 217 are made of materials that are pervious to light, the invention also has the advantage of displaying the operation status of the tray-type disk drive on the front faceplate 210.

Therefore, the ejecting apparatus discussed above has the following advantages: (1) the rod dose not need to be searched when required, it is convenient and time saving; (2) the rod will not be lost because it is installed in and attached on the front faceplate. Hence, the ejecting apparatus can eject the disk-receiver from the tray-type disk drive in an efficient way.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An ejecting apparatus applied in a tray-type disk drive with a disk tray, the ejecting apparatus comprising:
a driving device installed inside the tray-type disk drive, for ejecting the disk tray out from the tray-type disk drive;
a front faceplate with an aperture installed at the front of the tray-type disk drive; and
a rod slidbly installed in the aperture against the driving device, and an end of the rod protruding out of the front faceplate through the aperture, wherein, by pushing the rod the driving device is activated.

2. The ejecting apparatus according to claim 1, further comprising:
a spring connecting the rod to the front faceplate, wherein the spring is used to replace the rod after the rod is pushed.

3. The ejecting apparatus according to claim 1, further comprising:
a pushing rod connecting to the rod by a swivel pivot, the pushing rod being able to be rotated to align with the rod, wherein by pushing the pushing rod aligned with the rod, the driving device is activated and the pushing rod can be rotated to lie flat on the front faceplate.

4. The ejecting apparatus according to claim 1, further comprising:
a light-emitting device located around the rod, wherein the rod is made of a material transmitting to a light from the light-emitting device so that the light can be displayed through the rod.

5. The ejecting apparatus according to claim 4, wherein the light-emitting device is a light emitting diode (LED).

6. The apparatus according to claim 4, wherein the pushing rod is made of a material pervious to light, so that light emitted from the light-emitting device can be displayed through the rod and the pushing rod.

7. The ejecting apparatus according to claim 1, further comprising:
a light-emitting device located within the rod, for displaying an operation status oft he tray-type disk drive, wherein the rod is made of a material pervious to light so that light emitted from the light-emitting device can be displayed through the rod.

8. The ejecting apparatus according to claim 4, wherein the light-emitting device is a light emitting diode (LED).

9. The ejecting apparatus according to claim 7, further comprising:
a pushing rod, made of a material pervious to light, connecting to the rod by a swivel pivot, the pushing rod being able to be rotated to align with the rod, wherein by pushing the pushing rod aligned with the rod, the driving device is activated and the pushing rod can be rotated to lie flat on the front faceplate and light emitted from the light-emitting device can be displayed through the rod and the pushing rod.

10. An ejecting apparatus applied in a tray-type disk drive with a disk tray, the ejecting apparatus comprising:
a driving device installed inside the tray-type disk drive, for ejecting the disk tray out from the tray-type disk drive;
a front faceplate with an aperture installed at the front of the tray-type disk drive;
a rod in the aperture against the driving device, and an end of the rod protruding out of the front faceplate through the aperture, wherein, by pushing the rod the driving device is activated;
a pushing rod connecting to the rod by a swivel pivot, the pushing rod being able to be rotated to align with the rod, wherein by pushing the pushing rod aligned with the rod, the driving device is activated and the pushing rod can be rotated to lie flat on the front faceplate; and
a spring connecting the rod to the front faceplate, wherein the spring is used to replace the rod after the rod is pushed.

11. The ejecting apparatus according to claim 10, further comprising:
a light-emitting device located around the rod, for displaying an operation status of the tray-type disk drive, wherein the rod is made of a material pervious to light so that light emitted from the light-emitting device can be displayed through the rod.

12. The ejecting apparatus according to claim 11, wherein the light-emitting device is a light emitting diode (LED).

13. The ejecting apparatus according to claim 11, further comprising a pushing rod, made of a material pervious to light, so that light emitted from the light-emitting device can be displayed through the rod and the pushing rod.

14. The ejecting apparatus according to claim 10, further comprising:
a light-emitting device located within the rod, for displaying an operation status of the tray-type disk drive, wherein the rod is made of a material pervious to light so that light emitted from the light-emitting device can be displayed through the rod.

15. The ejecting apparatus according to claim 14, wherein the light-emitting device is a light emitting diode (LED).

16. The ejecting apparatus according to claim 11, further comprising a pushing rod, made of a material pervious to light, so that light emitted from the light-emitting device can be displayed through the rod and the pushing rod.
